(19) United States
(12) Patent Application Publication
(10) Pub. No.: US 2015/0109332 A1
(43) Pub. Date: Apr. 23, 2015

(54) REAL-TIME VISUALIZATIONS OF COMPONENTS IN A MODULAR INSTRUMENTATION CENTER

(71) Applicant: FMR LLC, BOSTON, MA (US)

(72) Inventors: Peter Manzoni, Westlake, TX (US); Joseph Aaron Higgins, Needham, MA (US)

(21) Appl. No.: 14/515,246

(22) Filed: Oct. 15, 2014

Related U.S. Application Data
(60) Provisional application No. 61/892,032, filed on Oct. 17, 2013.

(51) Int. Cl. G09G 5/377; G06F 3/0484

(52) U.S. Cl. CPC G09G 5/377; G06F 3/04842; G09G 2354/00; G09G 2340/12
USPC 345/629; 345/619

(57) ABSTRACT

A computer-implemented method for monitoring functions in an instrumentation center, the method comprising: accessing, by a monitoring system that monitors functional operation of the instrumentation center, layout information indicative of a layout of the instrumentation center, the layout information specifies a number of levels in the instrumentation center and types of components in each of the levels; detecting, by the monitoring system, a location of a portable display device that is connected over a network to the monitor system; and generating, from location data that specifies the location of the portable display device, information for a graphical user interface that when rendered on the portable display device renders a visualization of that portion of the instrumentation center in which the portable display device is currently located.

### CLAIM OF PRIORITY

This application claims priority under 35 U.S.C. §119(e) to U.S. Provisional Application No. 61/892,032, filed on Oct. 17, 2013, the entire contents of which are incorporated herein by reference.

### BACKGROUND

A modular instrumentation center is comprised of various modules, as described in co-pending US Patent Publication US-2012-0255710-A1 assigned to the assignee of the present invention. In the modular instrumentation center described in that co-pending US Patent Publication, there are three types of modules: power generation, instrumentation, and cooling. These modules are stacked together along a vertical direction to produce self-contained instrumentation centers and stacks that can be placed in a horizontal dimension. Also included is one or more circulation cores.

### SUMMARY

In an example, a computer-implemented method includes accessing, by a monitoring system that monitors functional operation of the instrumentation center, layout information indicative of a layout of the instrumentation center, the layout information specifies a number of levels in the instrumentation center and types of components in each of the levels; detecting, by the monitoring system, a location of a portable display device that is connected over a network to the monitor system; and generating, from location data that specifies the location of the portable display device, information for a graphical user interface that when rendered on the portable display device renders a visualization of that portion of the instrumentation center in which the portable display device is currently located. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some example, the graphical user interface is a first graphical user interface, and the method further comprises: generating, by one or more processing devices and based on the accessed layout information, information for a second graphical user interface that when rendered on a display device comprises: a visual representation of the instrumentation center; and one or more selectable portions, selection of which specifies a particular level at which a user requests to view system information; receiving information indicative of a selection of a selectable portion that corresponds to the particular level; for the selected, particular level in the instrumentation center, accessing, in real-time and from a data repository, system level information indicative of statuses of components that are located in the particular level; and generating, based on the accessed system level information for the particular, selected level of the instrumentation center, information for a third graphical user interface that when rendered on a display device comprises: a visual representation of the particular, selected level of the instrumentation center; and one or more visual representations of one or more real-time statuses of one or more of the components that are located in the particular level. A component comprises one or more of an electrical component, a mechanical component, and an infrastructure component. The actions include generating information for an overlay to the graphical user interface, with the overlay displaying information indicative of statuses of components in that portion of the instrumentation center in which the portable display device is currently located. The actions include detecting that the portable display device has moved from a first portion of the instrumentation center to a second portion of the instrumentation center; and updating, based on detecting, the visualization to include the second portion of the instrumentation center in which the portable display device is currently located. Detecting comprises: receiving, from a global positioning system component of the portable display device that renders the graphical user interface, information indicative of latitude and longitude coordinates of the portable display device; and detecting a change between (i) the received information indicative of latitude and longitude coordinates of the portable display device, and (ii) information indicative of prior latitude and longitude coordinates of the client device. The graphical user interface comprises a dashboard graphical user interface that further comprises: a visual representation indicative of alarms that are generated for various components in levels of the instrumentation center.

All or part of the foregoing may be implemented as a computer program product including instructions that are stored on one or more non-transitory machine-readable storage media and/or one or more machine-readable hardware storage devices that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages of the techniques described herein will be apparent from the description and drawings, and from the claims.

### DESCRIPTION OF DRAWINGS

FIG. 1 is a cross sectional view of a modular instrumentation center.

FIG. 2 is a diagram of a system for generating real-time visualizations of components of the modular instrumentation center.

FIG. 3 is a diagram of components of the system for generating real-time visualizations of components of the modular instrumentation center.

FIG. 4 is a flow diagram of a process for generating real-time visualizations of components of the modular instrumentation center.

FIG. 5 is a diagram of a hierarchical structure of types of graphical user interfaces for the modular instrumentation center.

FIGS. 6-12 are graphical user interfaces provided for the modular instrumentation center.

### DETAILED DESCRIPTION

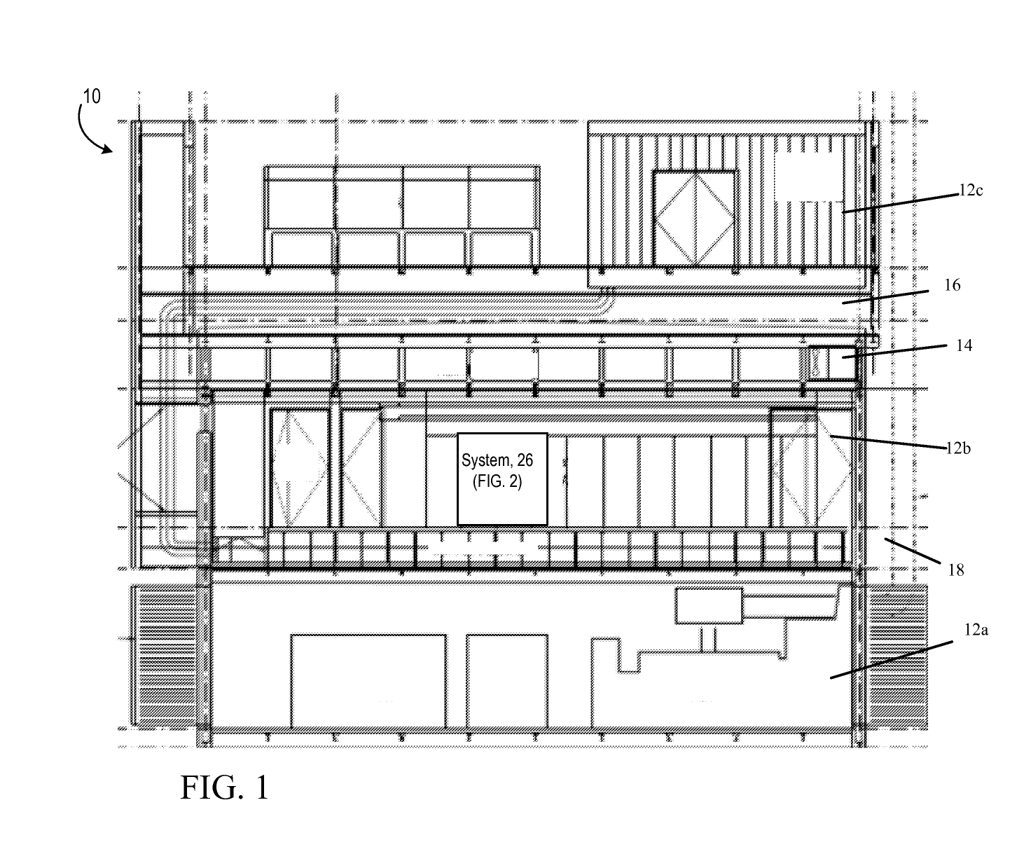

Referring to FIG. 1, modular instrumentation center 10 includes power generation 12a, instrumentation 12b, and cooling 12c. An instrumentation center is a center that includes electronic instruments, such as but not limited to, computer systems, network systems, typically embodied in so called data centers. However, other types of electronics equipment can be included such as electronic instruments for measurement, etc.

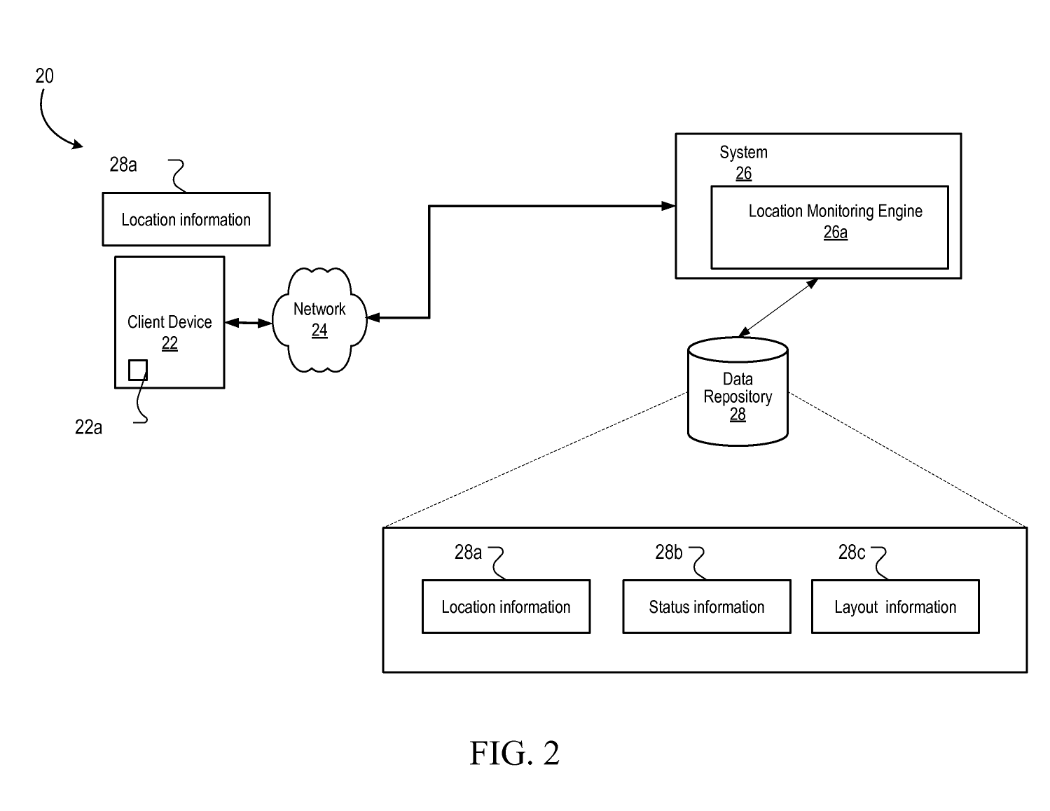

Modular instrumentation center 10 includes a plenum unit 14 above the instrumentation level 12b to provide a return for air and includes a roof assembly 16 above the instrumentation level 12b. The configuration also includes a plenum unit 18 below the instrumentation level 12b to supply cool air that is filtered up through the perforated floor of the instrumentation level 12b. The center 10 is particular useful in an urban setting where land is expensive and/or shielding of the power generators are especially necessary. The modular instrumentation center 10 also includes a system 26 (FIG. 2) that receives data from monitoring systems within the modular instrumentation center 10 and transmits the received data in an application to client devices 22 (FIG. 2). Alternatively, system 26 could be remote from the modular instrumentation center. An exemplary modular instrumentation center 10 is described in co-pending US Patent Publication US-2012-0255710-A1, which is assigned to the assignee of the present invention and is incorporated herein by reference in its entirety. Other types of instrumentation centers that allow for user ingress, circulation and egress can be used with the system to be described below.

Referring to FIG. 2, networked system 20 includes client device 22, network 24, modular instrumentation center 10 (FIG. 1) with system 26 and data repository 28. Client device 22 is used by a user (e.g., an engineer walking through an instrumentation center). Client device 22 is a portable computing system that a user can carry as the user walks through the modular instrumentation center 10 (FIG. 1).

System 26 monitors functions in the instrumentation center module 12b (FIG. 1), e.g., by monitoring temperature, humidity, water flow, water pressure and fire presence in the various components in the various levels of modular instrumentation center 10 (FIG. 1). System 26 also adjusts and operates functional operations of the various components, including, e.g., lowering a temperature, turning on lights, decreasing humidity, increasing water pressure, turning on fire suppression and so forth. Through a visual representation of a control in a graphical user interface, a user requests to send an instruction to the specific location and floor of the modular instrumentation center 10 (FIG. 1) to cause a change in a functional operation. The components and infrastructure are coupled or electrically connected to one or more remote controls that are initiated from an intranet or the Internet (e.g., via an instruction that is initiated through selection of a control in a graphical user interface). System 26 sends instructions to the controls (e.g., the remote controls) to implement one or more operations, e.g., turning on lights.

The systems and/or components in the modular instrumentation center 10 (FIG. 1) also include pneumatic controls that use air pressure to control temperature and other functions. These pneumatic controls are remotely controlled, e.g., via selection of a visual representation of a control in a graphical user interface. System 26 receives, from client device 22, a request to modify or adjust a component that is associated with a pneumatic control. In response, system 26 generates an instruction and transmits the instruction to the control (e.g., the pneumatic control) for execution.

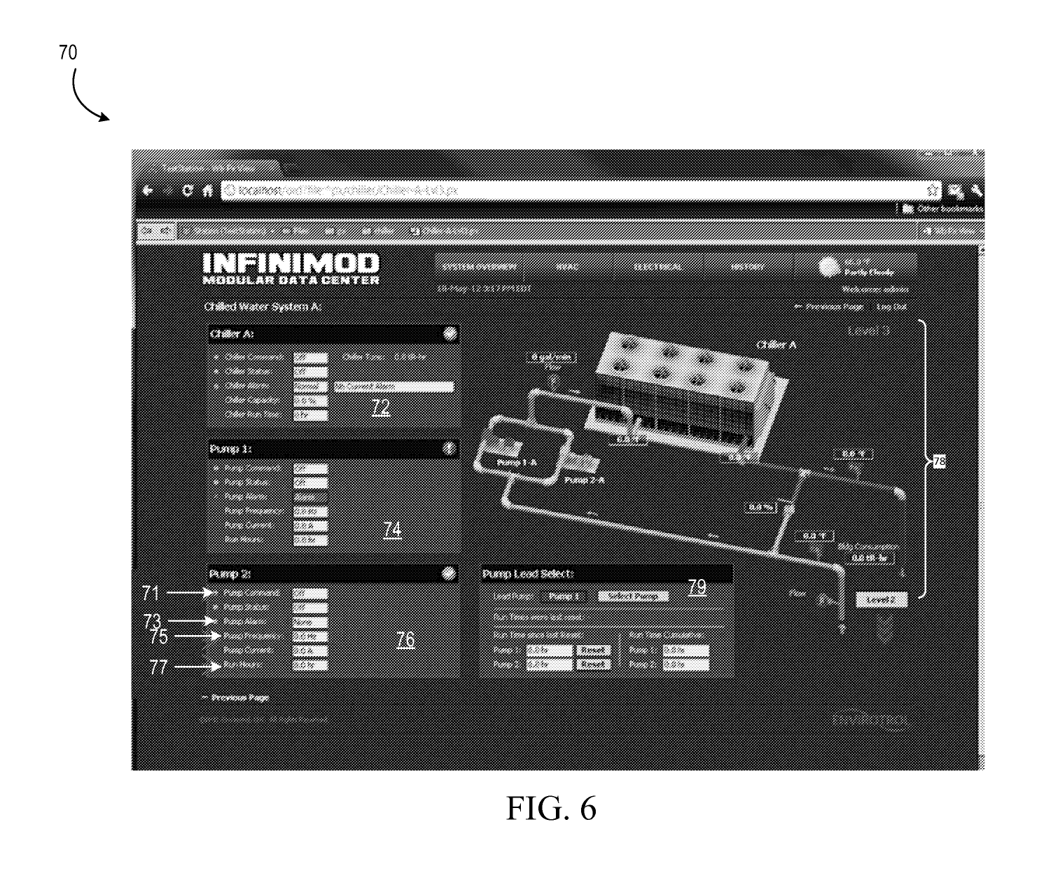

Client device 22 includes an application (not shown) for interfacing with system 26. In an example, upon selection of a control (and/or upon input of information in association with a control)—such as control 71 in FIG. 6, client device 22 sends to system 26 information indicative of the selected control and/or input information. In response, system 26 uses the input information (and/or information indicative of the selected control) to send an instruction to a component in modular instrumentation center 10 (FIG. 1) that is controlled via the selected control (and/or is associated with the input information). The instruction includes information specifying how a functional operation of the component is modified and/or updated. System 26 sends the instruction via network 24 (e.g., an intranet, the Internet, and so forth) to a processing device associated with and/or included in the component. The processing device is included in a remote control. The processing device receives the instruction and executes the instruction, e.g., to cause a change in a functional operation of the component.

The application launches a series of graphical user interfaces, described below. These graphical user interfaces are displayed on client device 22. The application includes software that is downloaded onto the client device 22 and is dedicated to communication with system 26. In an example, client device 22 downloads, via network 24, an application from system 26. The downloaded application is displayed on client device 22 and comprises an interactive dashboard (with controls) as described below. Through the downloaded application, client device 22 and system 26 communicate with each other.

The application (and/or client device 22) includes a global position system (GPS) component 22a to collect information indicative of a position of client device 22. The GPS component 22a collects location information 28a, which includes latitude and longitude coordinates of client device 22. Client device 22 transmits location information 28a to system 26.

System 26 receives location information 28a and stores it in data repository 28. System 26 includes location monitoring engine 26a for using location information 28a to determine what level of modular instrumentation center 10 (FIG. 1) is client device 22 located. In determining the level, location monitoring engine 26a stores and accesses a mapping of geographic coordinates to levels of modular instrumentation center 10 (FIG. 1), as shown in the below Table 1:

TABLE 1

| Coordinates | Level |
|---|---|
| aa-bb | Level 1 |
| cc-dd | Level 2 |
| ee-ff | Level 3 |

As shown in the above Table 1, various ranges of coordinates are mapped to various levels of modular instrumentation center 10 (FIG. 1). Latitude and longitude coordinates in the range of aa-bb are mapped to level 1 in modular instrumentation center 10 (FIG. 1). Latitude and longitude coordinates in the range of cc-dd are mapped to level 2 in modular instrumentation center 10 (FIG. 1). Latitude and longitude coordinates in the range of ee-ff are mapped to level 3 in modular instrumentation center 10 (FIG. 1). Location monitoring engine 26a determines geographic coordinates (i.e., latitude and longitude coordinates) included in location information 28a. Location monitoring engine 26a identifies a range of coordinates in the mapping that include the determined coordinates of location information 28a. Location monitoring engine 26a identifies a level in modular instrumentation center 10 (FIG. 1) that is mapped to the identified range. This identified level is the level in modular instrumentation center 10 (FIG. 1) in which client device 22 is presently located.

For a particular level, system 26 also determines a portion of the level at which client device 22 is located, e.g., to determine which components or infrastructure are in proximity to client device 22. By determining the portion of the level that the client device 22 is located in, system 26 provides the user with a view of the infrastructure that is in proximity to the user, rather than a view of the entire level. System 26 accesses a mapping of coordinates to infrastructure, as shown in the below Table 2.

TABLE 2

| Coordinates | Infrastructure |
|---|---|
| gg-hh | HVAC |
| ii-jj | CRAH |
| kk-ll | PUE |

As shown in the above Table 2, various ranges of coordinates are mapped to various types of infrastructure. Latitude and longitude coordinates in the range of gg-hh are mapped to HVAC components. Latitude and longitude coordinates in the range of ii-jj are mapped to CRAH components. Latitude and longitude coordinates in the range of kk-ll are mapped to PUE components. System 26 determines a range of coordinates that include the coordinates of location information 28a. Based on the determined range, system 26 determines which types of infrastructure are in proximity to client device 22 located on a specified level. By determining which types of infrastructure are in proximity to client device 22, system 26 provides users with a more granular view of the status of components that are on a particular level and that are in proximity to the user.

In a variation, GPS may not work inside of center 10. In this example, center 10 includes beacons and/or transmitters to send location information to client device 22. The location information sent includes the geographic location of the transmitting beacon or a location name (e.g., 3^{rd} level, right corner) for the location of the beacon. Client devices 22 receives this location information and in turn transmits it to system 26.

Data repository 28 also stores layout information 28c and status information 28b. Layout information 28c includes visualizations of the various levels in modular instrumentation center 10 (FIG. 1), visualizations of the infrastructure and components located in each level, and information specifying a location of the infrastructure and components in each level and their locations relative to each other. System 26 selects a portion of layout information 28c that pertains to the identified level at which the client device 22 is presently located and/or that pertains to particular infrastructure at a particular level at which the client device 22 is located. Using the selected portion of the layout information 28c, system 26 generates one or more graphical user interfaces that are rendered on client device 22 to display visualizations of the infrastructure and components (e.g., heating components, rack components, cooling components, and so forth) of a level (or a portion of a level) at which client device 22 is located.

Status information 28b includes information indicative of statuses of various components, infrastructure and systems within modular instrumentation center 10 (FIG. 1). Status information 28b indicates when a leak is detected, when a fire is detected in a portion of modular instrumentation center 10 (FIG. 1), a temperature of a component, water pressure, cooling and heating metrics, and so forth. The system components and infrastructure in modular instrumentation center 10 (FIG. 1) communicate with system 26 via network 24. The system components pass status information 28b to system 26, which stores the received status information in data repository 28. Alternatively, modular instrumentation center 10 (FIG. 1) includes a monitoring system (not shown) for collecting status information from the various components and infrastructure in modular instrumentation center 10 (FIG. 1). The monitoring system transmits status information 28b to system 26. In still another embodiment, system 26 and location monitoring engine 26a are integrated with and are part of modular instrumentation center 10 (FIG. 1).

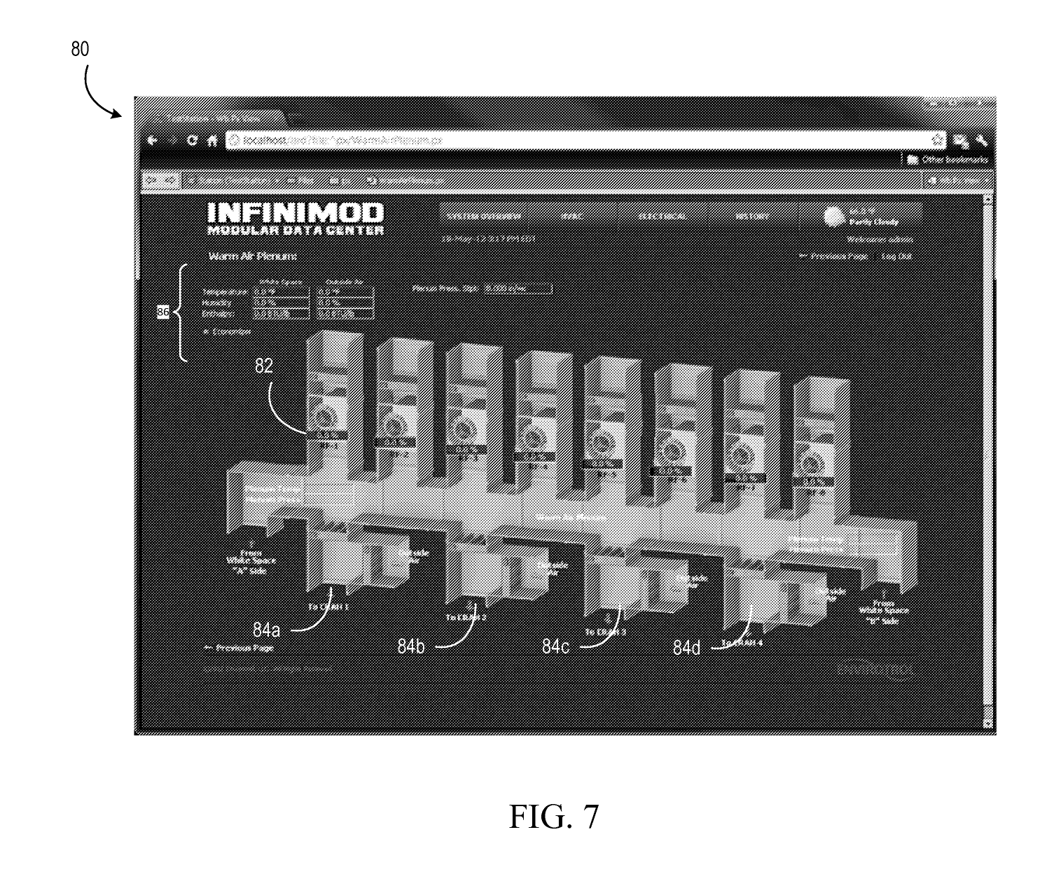

System 26 generates overlay information using the status information 28b. The overlay information provides an overlay to the visualization of a particular level and components of that level. The overlay information provides statuses (e.g., temperature, alert status, normal status, pressures, etc.) of the various components. The overlay information is displayed in a graphical user interface on top of a relevant component or in juxtaposition to the relevant component, e.g., as shown in FIG. 7. The status information 28b specifies an association between a particular item of status information 28b and a particular component or piece of infrastructure. The layout information 28c also specifies particular components and pieces of infrastructure. In generating a graphical user interface of a layout of a level with overlayed status information, system 26 identifies the components and infrastructure on a particular level, as specified in layout information 200. System 26 selects, from status information 28b, portions of status information 28b that pertain to the identified components and infrastructure. System 26 generates the graphical user interface by displaying the status information as an overlay to the visualization of the components and infrastructure, with status information being displayed juxtaposed to or in proximity to associated components and infrastructure.

Client device 22 periodically sends to system 26 updated location information, e.g., as client device 22 is moved around the various portions of modular instrumentation center 10 (FIG. 1) and as client device 22 is moved among the various levels. Using the updated location information, system 26 detects that client device 22 has moved locations, e.g., has moved from a first portion of the instrumentation center to a second portion of the instrumentation center. In particular, system 26 detects a change between (i) the updated information indicative of latitude and longitude coordinates of client device 22, and (ii) previously received information indicative of prior latitude and longitude coordinates of the client device 22. Based on the detected change, system 26 determines which level is mapped to a range of coordinates that includes the updated coordinates. Once a level is detected, system 26 also determines which components are in proximity to the client device 22 at the updated locations, e.g., based on contents of the mapping shown in Table 2. Based on the detected updated level (and/or updated proximity to infrastructure), system 26 updates the visualization to include the second portion of the instrumentation center in which the portable display device is currently located.

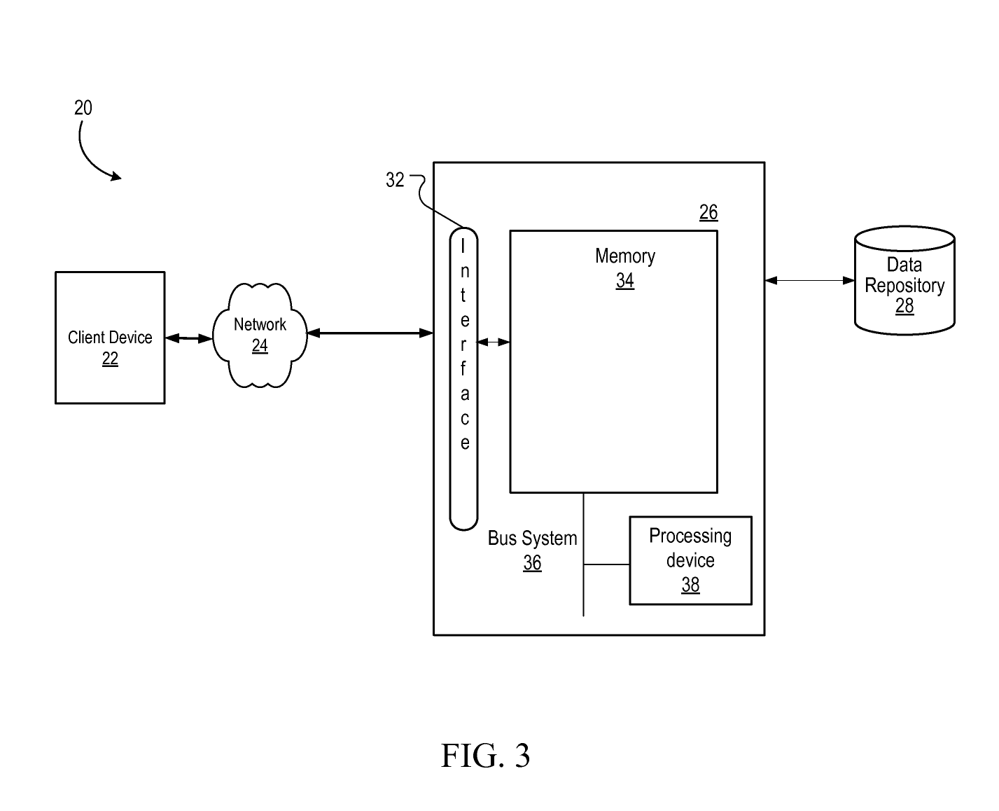

Referring to FIG. 3, client device 22 can be any sort of computing device capable of taking input from a user and communicating over network 24 with system 26 and/or with other client devices. For example, client device 22 can be a portable display device, a mobile device, a desktop computer, a laptop, a cell phone, a personal digital assistant (“PDA”), a server, an embedded computing system, an iPhone®, an iPad®, and so forth.

System 26 also includes memory 34, a bus system 36, and a processing device 38. Memory 34 can include a hard drive and a random access memory storage device, such as a dynamic random access memory, machine-readable media, a hardware storage device or other types of non-transitory machine-readable hardware storage devices. A bus system 36, including, for example, a data bus and a motherboard, can be used to establish and to control data communication between the components of system 26. Processing device 38 may include one or more microprocessors and/or processing devices. Generally, processing device 38 may include any appropriate processor and/or logic that is capable of receiving and storing data, and of communicating over a network.

System 26 can be any of a variety of computing devices capable of receiving data, such as a server, a distributed computing system, a desktop computer, a laptop, a cell phone, a rack-mounted server, and so forth. System 26 may be a single server or a group of servers that are at a same location or at different locations. System 26 receives data from client device 22 and modular instrumentation center 10 (FIG. 1) via input/output (“I/O”) interface 32. I/O interface 32 can be any type of interface capable of receiving data over a network, such as an Ethernet interface, a wireless networking interface, a fiber-optic networking interface, a modem, and so forth. Client device 22 and system 26 can communicate with each other over network 24 and can run programs having a client-server relationship to each other.

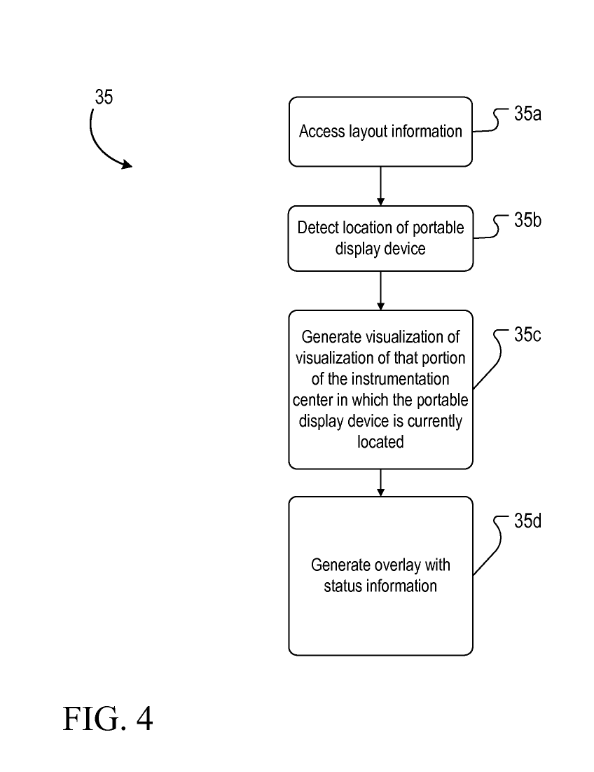

Referring now to FIG. 4, system 26 implements process 35 in generating a visualization of statuses of various components in a particular level of an instrumentation center. In operation, system 26 accesses (35a) layout information indicative of a layout of an instrumentation center. The layout information specifies a number of levels in the instrumentation center, and types of components in each of the levels. System 26 detects (35b) a location of a portable display device that is connected over a network to the monitor system (e.g., system 26). System 26 uses location information received from the portable display device to detect the location of the portable display device. System 26 also generates (35c) information for a graphical user interface that when rendered on a display device renders a visualization of that portion of the instrumentation center in which the portable display device is currently located. System 26 generates (35d) an overlay to the visualization that displays statuses and health information for the infrastructure included in that portion of the instrumentation center in which the portable display device is currently located. The visualization is for an entire level of the modular instrumentation center at which the portable display device is located. In another embodiment, the visualization is for those components in proximity (e.g., a predefined distance) to the portable display device in the level of the modular instrumentation center at which the portable display device is located.

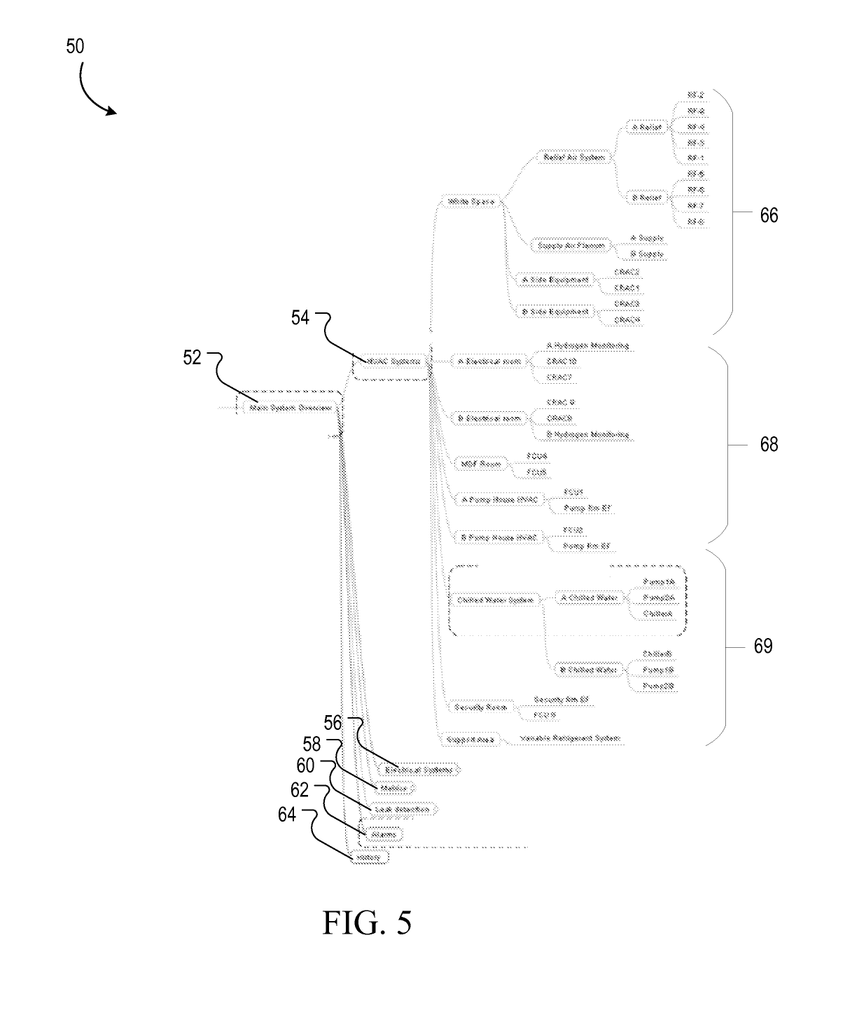

Referring to FIG. 5, diagram 50 shows a hierarchical structure of graphical user interfaces (GUIs) that are generated by system 26. GUI 52 provides a main system overview of the overall health of the various components of an instrumentation center. GUI 52 displays notifications of system errors and issues. From GUI 52, a user navigates to heating, ventilation and cooling (HVAC) system GUIs 54, electrical system GUIs 56, metrics GUIs 58, leak detection GUIs 60, alarms GUIs 62 and/or history GUIs 64.

HVAC system GUIs 54 provide information on the heating, ventilation and cooling components of a modular instrumentation center. HVAC system GUIs 54 provide information on HVAC components 66, 68 and 69. HVAC components 66 include white space components. Generally, white space includes a raised floor area where the computing equipment resides. There are various types of white space components, e.g., a relief air system, a supply air plenum, and side equipment. For a particular white space component, a user may view increasingly granular information of sub-components (e.g., the “A” relief portion of the relief air system and portion RF-2 of the A relief portion).

HVAC components 68 include electrical room components, main distribution frame (MDF) components and pump house components. For each of these components, a user obtains more granular information by navigating to related GUIs with more granular information. For example, a user navigates from a GUI displaying information about an electrical room to another GUI displaying information about hydrogen monitoring in the electrical room. HVAC components 69 include chilled water system components, security room components, and support area components.

Metrics GUIs 58 display information about metrics for the instrumentation center, e.g., water pressure metrics, temperature metrics, cooling metrics, electricity metrics, and so forth. Leak detection GUIs 60 provide information indicative of leaks in the instrumentation center. Alarm GUIs 62 provide information indicative of failures in the instrumentation center and issues that require user intervention. History GUIs 64 provide information indicative of performance of the instrumentation center over a period of time.

Referring to FIG. 6, graphical user interface 70 displays information indicative of the status of a chilled water system in the instrumentation center. If the chilled water system is located on a particular level, then graphical user interface 70 is displayed when a client device (carried by a user) enters the particular level or when the client device enters the particular level and the portion of the level housing the chilled water system. Graphical user interface 70 includes portions 72, 74, 76, 79 for display of information indicative of a chiller in the water system, first and second pumps in the water system and a selected lead pump, respectively. Graphical user interface 70 also displays visualization 78 that displays locations of the various components of the chilled water system.

Graphical user interface 70 includes various controls, e.g., controls 71, 73, 75, 77. Generally, a control is a portion of a graphical user interface for a user to input one or more commands to be executed to control a component or item of infrastructure. Control 71 is a pump command control that enables a user to turn a pump in a chilled water system either on or off. Control 71 is associated with an input box, e.g., for a user to enter information changing a status (on or off) of the pump. Graphical user interface 70 also includes pump alarm control 73, e.g., for clearing alarms that are associated with the pump. Graphical user interface 70 also includes pump frequency control 75, e.g., for a user to specify a frequency (in Hz) at which the pump should operate. Graphical user interface 70 also includes run hours control 77, e.g., for a user to specify a number of hours for the pump to run.

In addition to monitoring of temperature, humidity, water flow, water pressure and for fire among other things, the graphical user interfaces (not shown) also include various controls for controlling the various components that are located within the various levels of the instrumentation center. A control is used to perform various operations, including, e.g., lowering a temperature, turning on lights, decreasing humidity, increasing water pressure, turning on fire suppression, and so forth. Through a visual representation of a control in a graphical user interface, a user may select the control (or a portion thereof) to send an instruction to the specific location and floor of the instrumentation center to cause a change in temperature, humidity, water pressure, lighting, and so forth. The various systems and/or components have a remote control that can be initiated from the intranet or internet.

Referring to FIG. 7, graphical user interface 80 displays visualization 82 of a warm air plenum of the instrumentation center, e.g., to enable a user to monitor the functionality of the plenum. Visualization 82 includes portions 84a-84d to display air pathways of the warm air plenum. Graphical user interface 80 also includes portion 86 to display information indicative of temperature, humidity and enthalpy of the warm air plenum.

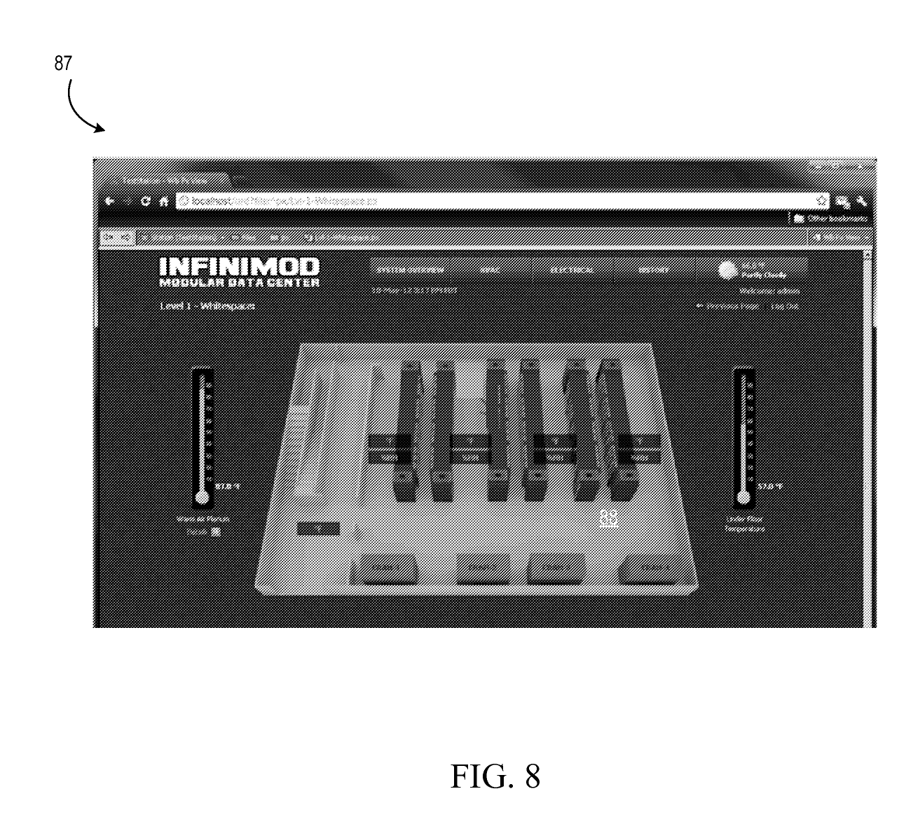

Referring to FIG. 8, graphical user interface 87 displays information about infrastructure in the white spice in level 1, e.g., when a user enters level 1 and/or when a user enters the white space portion of level 1. Graphical user interface 87 display visualization 88 with the racks in the white space and computer room air handlers (CRAH) in the white space on level 1. A CRAH is a device to circulate and/or cool the heat produced by equipment. Graphical user interface 87 also provides visual representations of a temperature of the warm air plenum and an under floor temperature. Graphical user interface 87 also provides visual representations of an ambient temperature surrounding the racks.

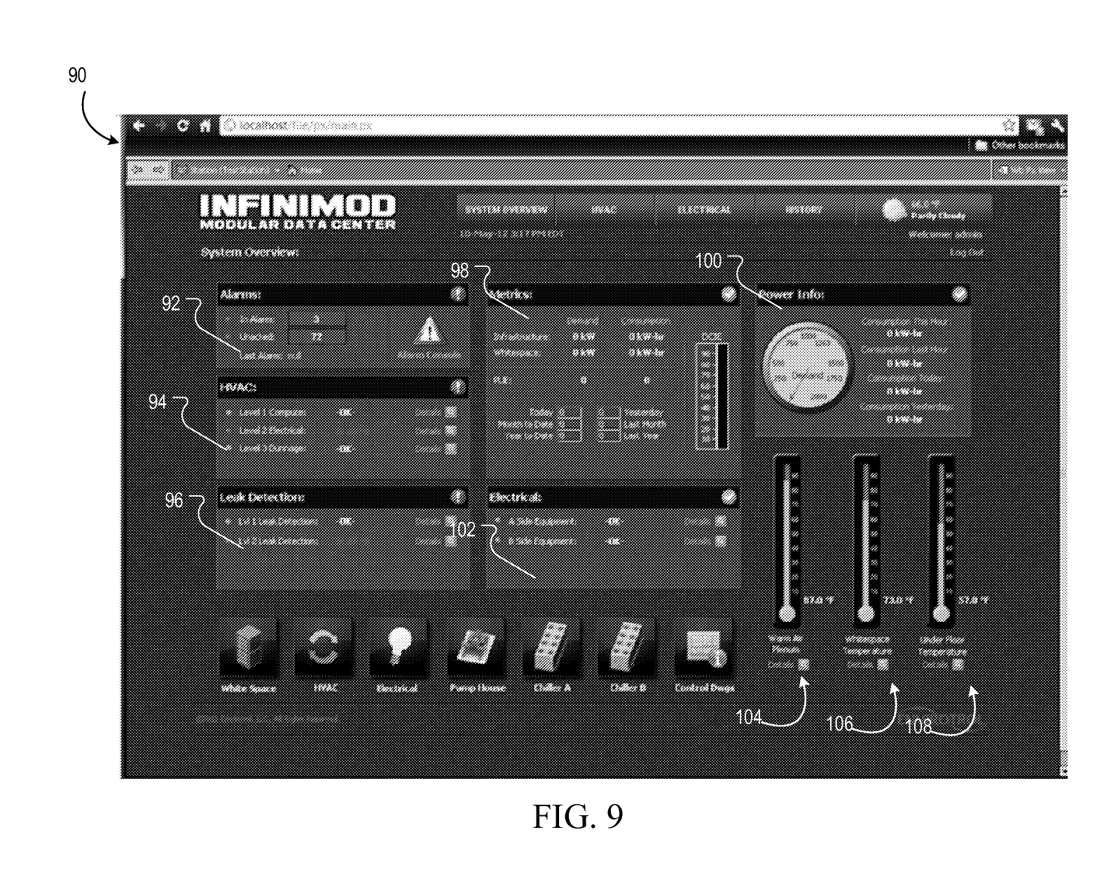

Referring to FIG. 9, graphical user interface 90 is an interactive monitoring dashboard for an instrumentation center. Through graphical user interface 90, a user observes performance of system components and power usage efficiencies (PUE) via a computer device (e.g., a portable computer, such as a smart phone, a tablet such as an iPAD® (Apple, Inc.), a notebook, a mobile computing device, a mobile phone, or a desktop device) and from a main command center. Graphical user interface 90 shows the electrical, mechanical, and infrastructure systems (and status of the systems) in real-time.

Graphical user interface 90 displays alarm portion 92 to provide a user with notification of a number of current, pending alarms (“in alarm”) and a number of unacknowledged alarms. Graphical user interface 90 includes HVAC portion 94 to display information indicative of HVAC statuses (e.g., OK or alarm) in the various levels of the instrumentation center. If an HVAC status displays an alarm, the user can select the displayed alarm to view details about the cause of the alarm.

Graphical user interface 90 includes leak detection portion 96 to display information indicative of detected leaks in the various levels of the instrumentation centers. When a leak is detected, an alarm visualization is displayed in portion 96. Through selection of the alarm visualization, a user is presented with details regarding the location and/or the cause of the alarm. When a level does not have an alarm, an “OK” message is displayed.

Graphical user interface 90 includes metrics portion 98 to display information indicative of a consumed amount of energy or electricity and information indicative of power usage effectiveness (PUE), which is a measure of how efficiently a computer instrumentation center uses energy; specifically, how much energy is used by the computing equipment (in contrast to cooling and other overhead). Graphical user interface 90 also includes power portion 100 to display information indicative of an amount of power that is consumed by the instrumentation center at various time intervals. Graphical user interface 90 includes electrical portion 102 to display information indicative of statuses (e.g., a pass status or an alarm status) of the electrical equipment. Graphical user interface 90 includes visualizations 104, 106, 108 to display the warm air plenum temperature, the white space temperature and the under floor temperature, respectively.

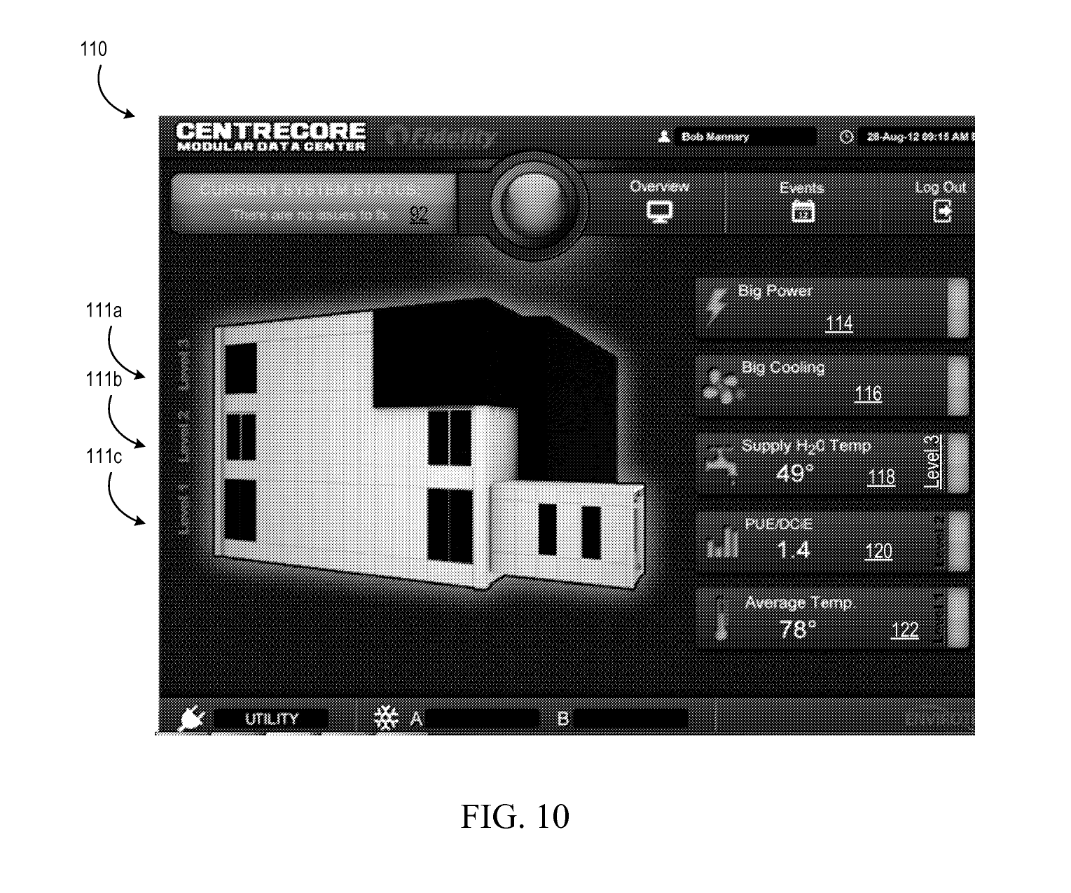

Referring to FIG. 10, graphical user interface 110 displays category status indicators 114, 116, 118, 120, 122 that enable a user to identify the health of primary system components (e.g., power components, cooling components, water components, PUE components, and temperature components). A category status indicator is color coded (green, yellow, red) to specify a health of a component and to provide a visualization of the component health. Green indicates normal operation. Yellow indicates a warning or a potential malfunction. Red indicates a malfunction. Additionally, a category status indicator may specify which level of the instrumentation center holds the infrastructure for that category. Category status indicator 118 specifies that the temperature components are on level 3.

Graphical user interface 110 includes level links 111a-111c, selection of which displays information for the selected level (e.g., status indicators for components located on the selected level). Upon selection of one of level links 111a-111c, a system (system 26 in FIG. 1) receives information specifying which one of level links 111a-111c is selected. For the selected, particular level in the instrumentation center, system 26 accesses, in real-time and from a data repository, system level information indicative of statuses of components that are located in the particular level. System 26 generates, based on the accessed system level information for the particular, selected level of the instrumentation center, information for a graphical user interface that when rendered on a display device comprises: a visual representation of the particular, selected level of the instrumentation center; and one or more visual representations of one or more real-time statuses of one or more of the components that are located in the particular level, e.g., as shown in FIG. 8.

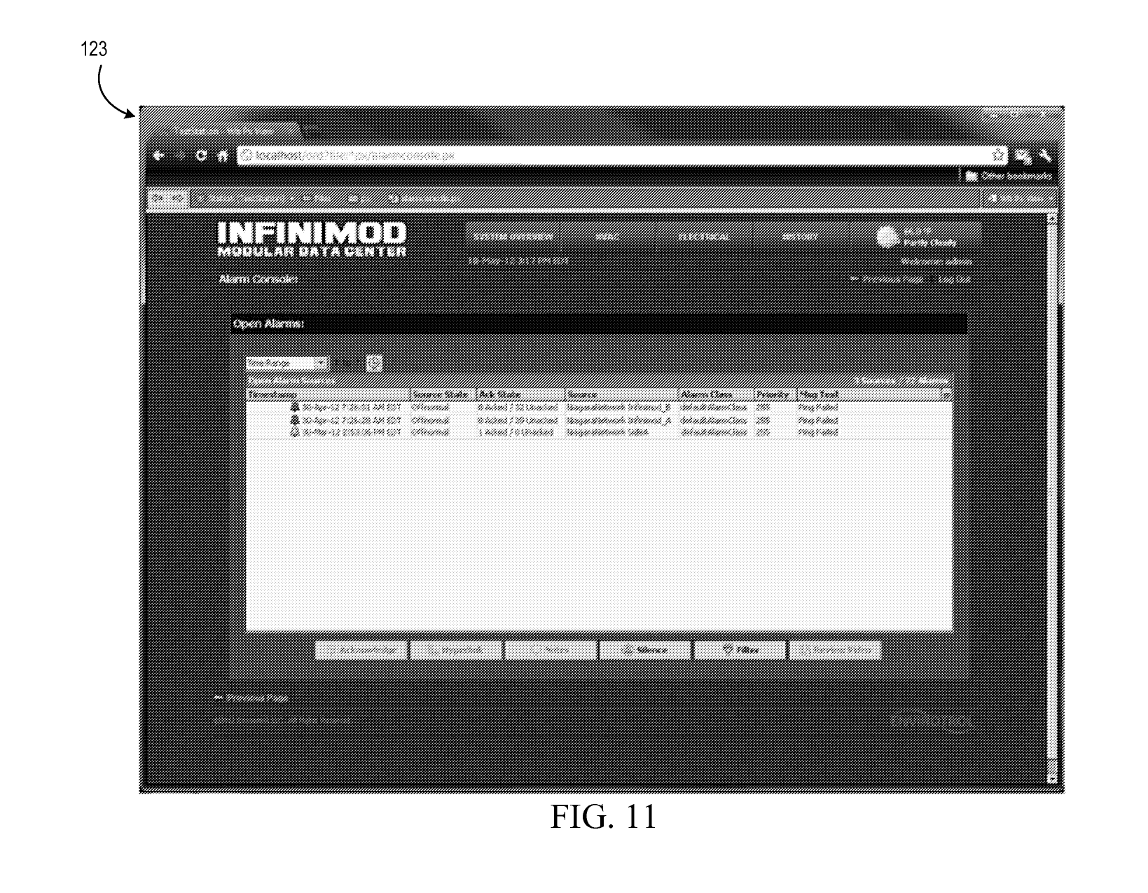

Referring to FIG. 11, graphical user interface 123 displays a listing of alarms that are generated for various components of the instrumentation center. The instrumentation center includes a monitoring component to detect when a component of the instrumentation center malfunctions. When a monitoring component (e.g., in system 26 or in center 10) detects a malfunction, it generates an alarm and displays the alarm in graphical user interface 123. The alarms displayed in graphical user interface 123 are filterable by instrumentation center level, e.g., to only display those alarms for components or hardware on a selected level of the instrumentation center.

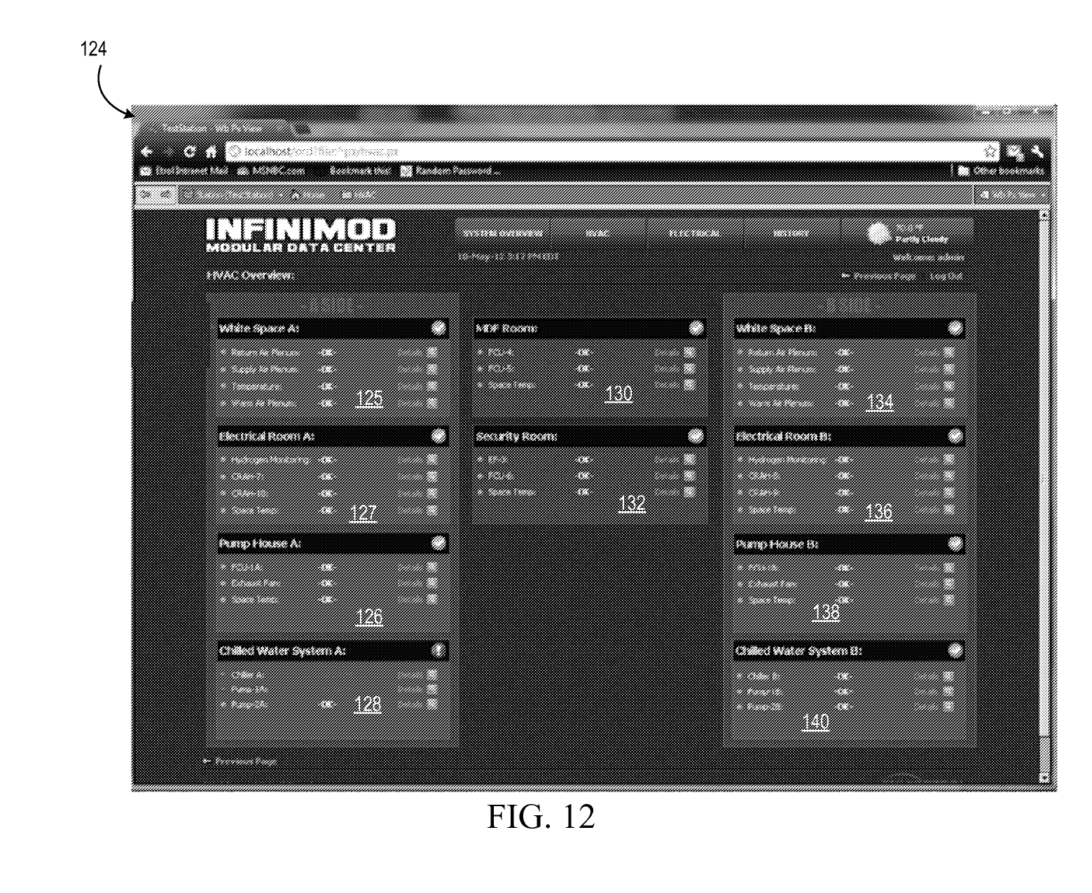

Referring to FIG. 12, graphical user interface 124 provides an overview of the functioning of the HVAC system on various sides of the instrumentation center (e.g., a left side and a right side, side A and side B, and so forth). Graphical user interface 124 includes portions 125, 127, 126, 128, 130, 132 to provide information indicative of statuses of white space infrastructure, electrical components, pump components, chilled water components, MDF room components, and security room components, respectively, in the A side of the instrumentation center. Graphical user interface 124 includes portions 134, 136, 138, 140 to provide information indicative of statuses of white space infrastructure, electrical components, pump components, and chilled water components, respectively, in the B side of the instrumentation center.

Using the techniques described herein, a modular instrumentation center includes multiple, structural levels, with each level housing a particular type of equipment. One of the levels includes instrumentation center systems. A second level includes power systems and a third level includes cooling systems. A user walks around the instrumentation center carrying a client device, e.g., an iPAD®, and views the equipment operations in real time, as well as being notified of alerts. The client devices includes an application or dedicated software to interface with the modular instrumentation center. As the user traverses the various levels of the instrumentation center, a location monitoring system (which may be integrated with the instrumentation center or separate from the instrumentation center) tracks the location of the user and tracks the user's traversal through the various levels. The location monitoring system causes the application to be updated in real-time to display information pertaining to infrastructure located on a level with the user (e.g., the level at which the user is presently located). As the user traverses among the levels of the instrumentation center, the application is updated in real-time to display infrastructure information for a level on which the user is located.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

Other embodiments are within the scope and spirit of the description claims. For example, any of the graphical user interfaces described herein may display information for a particular level of a modular instrumentation center, upon detecting that a user has entered the particular level. The displayed information for a particular level may include layout information with an overlay of status information. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of embodiments of the invention have been described. Nevertheless, it will be understood that various modifications may be made without departing from the spirit and scope of the invention.

1. A computer-implemented method for monitoring functions in an instrumentation center, the method comprising:
accessing, by a monitoring system that monitors functional operation of the instrumentation center, layout information indicative of a layout of the instrumentation center, the layout information specifies a number of levels in the instrumentation center and types of components in each of the levels;
detecting, by the monitoring system, a location of a portable display device and a level in the instrumentation center at which the portable display device is physically located, with the portable display device being connected over a network to the monitories system; and
generating, from location data that specifies the location and the level of the portable display device, information for a graphical user interface that when rendered on the portable display device renders a visualization of real-time status information for components on the detected level in that portion of the instrumentation center in which the portable display device is currently located.

2. The computer-implemented method of claim 1, wherein the graphical user interface is a first graphical user interface, and wherein the method further comprises:
generating, by one or more processing devices and based on the accessed layout information, information for a second graphical user interface that when rendered on a display device comprises:
a visual representation of the instrumentation center; and
one or more selectable portions, selection of which specifies a particular level at which a user requests to view system information;
receiving information indicative of a selection of a selectable portion that corresponds to the particular level;
for the selected, particular level in the instrumentation center,
accessing, in real-time and from a data repository, system level information indicative of statuses of components that are located in the particular level; and
generating, based on the accessed system level information for the particular, selected level of the instrumentation center, information for a third graphical user interface that when rendered on a display device comprises:
a visual representation of the particular, selected level of the instrumentation center; and
one or more visual representations of one or more real-time statuses of one or more of the components that are located in the particular level.

3. The computer-implemented method of claim 1, wherein a component comprises one or more of an electrical component, a mechanical component, and an infrastructure component.

4. The computer-implemented method of claim 1, further comprising:
generating information for an overlay to the graphical user interface, with the overlay displaying information indicative of statuses of the components in that portion of the instrumentation center in which the portable display device is currently located.

5. The computer-implemented method of claim 1, further comprising:
detecting that the portable display device has moved from a first portion of the instrumentation center to a second portion of the instrumentation center; and
updating, based on detecting, the visualization to include the second portion of the instrumentation center in which the portable display device is currently located.

6. The computer-implemented method of claim 4, wherein detecting comprises:
receiving, from a global positioning system component of the portable display device that renders the graphical user interface, information indicative of latitude and longitude coordinates of the portable display device; and
detecting a change between (i) the received information indicative of latitude and longitude coordinates of the portable display device, and (ii) information indicative of prior latitude and longitude coordinates of the client device.

7. The computer-implemented method of claim 1, wherein the graphical user interface comprises a dashboard graphical user interface that further comprises:
a visual representation indicative of alarms that are generated for various components in levels of the instrumentation center.

8. One or more machine-readable hardware storage devices storing instructions that are executable by a monitoring system, which is for monitoring functions in an instrumentation center, to perform operations comprising:
accessing, by the monitoring system that monitors functional operation of the instrumentation center, layout information indicative of a layout of the instrumentation center, the layout information specifies a number of levels in the instrumentation center and types of components in each of the levels;
detecting, by the monitoring system, a location of a portable display device and a level in the instrumentation center at which the portable display device is physically located, with the portable display device being connected over a network to the monitories system; and
generating, from location data that specifies the location and the level of the portable display device, information for a graphical user interface that when rendered on the portable display device renders a visualization of real-time status information for components on the detected level in that portion of the instrumentation center in which the portable display device is currently located.

9. The one or more machine-readable hardware storage devices of claim 8, wherein the graphical user interface is a first graphical user interface, and wherein the operations further comprise:
generating, based on the accessed layout information, information for a second graphical user interface that when rendered on a display device comprises:
a visual representation of the instrumentation center; and
one or more selectable portions, selection of which specifies a particular level at which a user requests to view system information;
receiving information indicative of a selection of a selectable portion that corresponds to the particular level;
for the selected, particular level in the instrumentation center,
accessing, in real-time and from a data repository, system level information indicative of statuses of components that are located in the particular level; and
generating, based on the accessed system level information for the particular, selected level of the instrumentation center, information for a third graphical user interface that when rendered on a display device comprises:
a visual representation of the particular, selected level of the instrumentation center; and
one or more visual representations of one or more real-time statuses of one or more of the components that are located in the particular level.

10. The one or more machine-readable hardware storage devices of claim 8, wherein a component comprises one or more of an electrical component, a mechanical component, and an infrastructure component.

11. The one or more machine-readable hardware storage devices of claim 8, wherein the operations further comprise:
generating information for an overlay to the graphical user interface, with the overlay displaying information indicative of statuses of the components in that portion of the instrumentation center in which the portable display device is currently located.

12. The one or more machine-readable hardware storage devices of claim 8, wherein the operations further comprise:
detecting that the portable display device has moved from a first portion of the instrumentation center to a second portion of the instrumentation center; and
updating, based on detecting, the visualization to include the second portion of the instrumentation center in which the portable display device is currently located.

13. The one or more machine-readable hardware storage devices of claim 12, wherein detecting comprises:
receiving, from a global positioning system component of the portable display device that renders the graphical user interface, information indicative of latitude and longitude coordinates of the portable display device; and
detecting a change between (i) the received information indicative of latitude and longitude coordinates of the portable display device, and (ii) information indicative of prior latitude and longitude coordinates of the client device.

14. The one or more machine-readable hardware storage devices of claim 8, wherein the graphical user interface comprises a dashboard graphical user interface that further comprises:
a visual representation indicative of alarms that are generated for various components in levels of the instrumentation center.

15. An electronic system comprising:
a monitoring system for monitoring functions in an instrumentation center; and
one or more machine-readable hardware storage devices storing instructions that are executable by the monitoring system to perform operations comprising:
accessing, by a monitoring system that monitors functional operation of the instrumentation center, layout information indicative of a layout of the instrumentation center, the layout information specifies a number of levels in the instrumentation center and types of components in each of the levels;
detecting, by the monitoring system, a location of a portable display device and a level in the instrumentation center at which the portable display device is physically located, with the portable display device being connected over a network to the monitoring system; and
generating, from location data that specifies the location and the level of the portable display device, information for a graphical user interface that when rendered on the portable display device renders a visualization of real-time status information for components on the detected level in that portion of the instrumentation center in which the portable display device is currently located.

16. The electronic system of claim 15, wherein the graphical user interface is a first graphical user interface, and wherein the operations further comprise:
generating, based on the accessed layout information, information for a second graphical user interface that when rendered on a display device comprises:
a visual representation of the instrumentation center; and
one or more selectable portions, selection of which specifies a particular level at which a user requests to view system information;
receiving information indicative of a selection of a selectable portion that corresponds to the particular level;
for the selected, particular level in the instrumentation center,
accessing, in real-time and from a data repository, system level information indicative of statuses of components that are located in the particular level; and
generating, based on the accessed system level information for the particular, selected level of the instrumentation center, information for a third graphical user interface that when rendered on a display device comprises:
a visual representation of the particular, selected level of the instrumentation center; and
one or more visual representations of one or more real-time statuses of one or more of the components that are located in the particular level.

17. The electronic system of claim 15, wherein a component comprises one or more of an electrical component, a mechanical component, and an infrastructure component.

18. The electronic system of claim 15, wherein the operations further comprise:
generating information for an overlay to the graphical user interface, with the overlay displaying information indicative of statuses of the components in that portion of the instrumentation center in which the portable display device is currently located.

19. The electronic system of claim 15, wherein the operations further comprise:
detecting that the portable display device has moved from a first portion of the instrumentation center to a second portion of the instrumentation center; and
updating, based on detecting, the visualization to include the second portion of the instrumentation center in which the portable display device is currently located.

20. The electronic system of claim 19, wherein detecting comprises:
receiving, from a global positioning system component of the portable display device that renders the graphical user interface, information indicative of latitude and longitude coordinates of the portable display device; and
detecting a change between (i) the received information indicative of latitude and longitude coordinates of the portable display device, and (ii) information indicative of prior latitude and longitude coordinates of the client device.

21. The electronic system of claim 15, wherein the graphical user interface comprises a dashboard graphical user interface that further comprises:
a visual representation indicative of alarms that are generated for various components in levels of the instrumentation center.

22. A computer-implemented method for monitoring functions in an instrumentation center, the method comprising:
accessing, by a monitoring system that monitors functional operation of the instrumentation center, layout information indicative of a layout of the instrumentation center, the layout information specifies a number of levels in the instrumentation center and types of components in each of the levels;
detecting, by the monitoring system, a location of a portable display device that is connected over a network to the monitoring system;
identifying, by the monitoring system based on the detected location, a level of the instrumentation center in which the portable display device is located;
determining by the monitoring system real-time status information for the components on the identified level and in a portion of the instrumentation center in which the portable display device is currently located;
generating information for a graphical user interface that when rendered on the portable display device renders a visualization of the determined real-time status information for the components on the identified level and in that portion of the instrumentation center in which the portable display device is currently located; and
transmitting, to the portable display device via the connection between the portable display device and the monitoring system that monitors functional operation of the instrumentation center, the generated information.
